(19) United States
(12) Patent Application Publication
(10) Pub. No.: US 2012/0170900 A1
(43) Pub. Date: Jul. 5, 2012

(54) Aluminum Alloy Conductor Composite Reinforced for High Voltage Overhead Power Lines

(75) Inventors: Michael L. Fancher, Cumming, GA (US); Jean-Marie Asselin, Mississauga (CA); Steven R. Goodman, Williamsport, PA (US); Bruce F. Vaughn, Cumming, GA (US)

(73) Assignee: ALCAN PRODUCTS CORPORATION, Atlanta, GA (US)

(21) Appl. No.: 12/985,073

(22) Filed: Jan. 5, 2011

(51) Int. Cl. G02B 6/44; H01R 43/00

(52) U.S. Cl. 385/101; 29/825

(57) ABSTRACT

Embodiments of the invention relate to aluminum alloy conductor composite reinforced for high voltage overhead power lines and associated methods of use and manufacture. In one embodiment, a transmission cable can be provided. The transmission cable can include a core including at least one of: a composite core, a plurality of fibers in a matrix of one or more materials, or a set of carbon fibers embedded in an epoxy matrix; and a plurality of wires wrapped around the core, wherein the wires comprise at least one of the following: aluminum 6201 T83 alloy, aluminum 6201 T81 alloy, aluminum 1350-H19 alloy, or a heat resistant aluminum-zirconium alloy; wherein the transmission cable has a low sag characteristic.

### TECHNICAL FIELD

The invention relates generally to cable, and more particularly to an aluminum alloy conductor composite reinforced for high voltage overhead power lines.

### BACKGROUND OF THE INVENTION

Existing conventional conductors can be used for transmission cables in high voltage overhead power line applications. These conventional conductors and associated transmission cables have been designed to withstand relatively high temperatures caused by the transmission of high voltage electrical currents. Furthermore, when conventional conductors and associated transmission cables span between two power transmission structures or towers, the conventional conductors and associated transmission cables sag between the two power transmission structures or towers due to the weight of the conductors and transmission cables. In certain weather conditions, such as when water on the overhead power line transmission cables freezes, these conventional conductors and associated transmission cables can become weighted or loaded down with ice, which increases the sag of the conductors and transmission cables. Sometimes, when the ice weight or loading exceeds a certain limit, the overhead power line transmission cables can break or otherwise sag just above the ground, resulting in power transmission failure or a hazardous condition.

For example, one conventional conductor and associated transmission cable can be made with a composite core surrounded by numerous 1350 H0 aluminum wires. This conventional conductor and associated transmission cable have limited ice loading capacity since the composite core has about ⅔ the modulus of steel wires typically used as the central structural member in bare conductors used for overhead power line transmission cable applications. Further, the 1350 H0 aluminum wires has approximately 30% elongation but very low tensile strength. When subjected to ice loading, the mechanical load imposed by the weight of the ice on this conventional conductor and associated transmission cable is transferred to the composite core which begins to sag or otherwise fail when certain mechanical loads are achieved.

Therefore, a need exists for improved conductors used for transmission cables in high voltage overhead power line applications.

### SUMMARY OF THE INVENTION

Embodiments of the invention can provide some or all of the above needs. Certain embodiments of the invention can provide aluminum alloy conductor composite reinforced for high voltage overhead power lines and associated methods of use and manufacture. In one embodiment, a transmission cable can be provided. The transmission cable can include a core including at least one of: a composite core, a plurality of fibers in a matrix of one or more materials, or a set of carbon fibers embedded in an epoxy matrix; and a plurality of wires wrapped around the core, wherein the wires comprise at least one of the following: aluminum 6201 T83 alloy, 6201 T81 alloy, aluminum 1350-H19 alloy, or a heat resistant aluminum-zirconium alloy; wherein the transmission cable has a low sag characteristic.

In one aspect of an embodiment, each of the plurality of wires can have a cross-section profile shape which can include a trapezoid shape or a round shape.

In one aspect of an embodiment, each of the plurality of wires can include a trapezoid cross-section profile shape, and the wires are oriented to form a plurality of concentrically aligned layers of wires around the core.

In one aspect of an embodiment, the plurality of wires can include at least two concentrically aligned layers of wires around the core.

In one aspect of an embodiment, the plurality of concentrically aligned layers of wires around the core can include at least three layers.

In one aspect of an embodiment, the plurality of wires are helically wrapped around the core.

In one aspect of an embodiment, the low sag characteristic can be between approximately 40.0 and 48.0 feet (12.2-14.6 m) of sag with an ice thickness of approximately 1.25 inches (3.2 cm) on the transmission cable spanning about 1400 linear feet (426.7 m).

In one aspect of an embodiment, the low sag characteristic can be between approximately 63.0 feet (19.2 m) and 90.2 feet (27.5 m) of sag with an ice thickness of approximately 2.0 inches (5.1 cm) on the transmission cable spanning about 1400 linear feet (426.7 m).

In another embodiment, a method for making a transmission cable can be provided. The method can include providing a core including at least one of: a composite core, a plurality of fibers in a matrix of one or more materials, or a set of carbon fibers embedded in an epoxy matrix; providing a plurality of wires, wherein the wires comprise at least one of the following: aluminum 6201 T83 alloy, 6201 T81 alloy, aluminum 1350-H19 alloy, or a heat resistant aluminum-zirconium alloy; and wrapping the plurality of wires around the core to form a transmission cable; wherein the transmission cable has a low sag characteristic.

In one aspect of an embodiment, each of the plurality of wires can have a cross-section profile shape which can include a trapezoid shape or a round shape.

In one aspect of an embodiment, each of the plurality of wires can include a trapezoid cross-section profile shape, and the wires are oriented to form a plurality of concentrically aligned layers of wires around the core.

In one aspect of an embodiment, the plurality of wires can include at least three concentrically aligned layers of wires around the core.

In one aspect of an embodiment, the plurality of concentrically aligned layers of wires around the core can include at least three layers.

In one aspect of an embodiment, the low sag characteristic can be between approximately 40.0 and 48.0 feet (12.2-14.6 m) of sag with an ice thickness of approximately 1.25 inches (3.2 cm) on the transmission cable spanning about 1400 linear feet (426.7 m).

In one aspect of an embodiment, the low sag characteristic can be between approximately 63.0 feet (19.2 m) and 90.2 feet (27.5 m) of sag with an ice thickness of approximately 2.0 inches (5.1 cm) on the transmission cable spanning about 1400 linear feet (426.7 m).

In one aspect of an embodiment, wrapping the plurality of wires around the core to form a transmission cable can include helically wrapping the plurality of wires around the core.

In another embodiment, a transmission system can be provided. The transmission system can include a transmission cable and at least one electrical current source. The transmission cable can include a core with at least one of: a composite core, a plurality of fibers in a matrix of one or more materials, or a set of carbon fibers embedded in an epoxy matrix; and a plurality of wires helically wrapped around the core, wherein the wires can include at least one of the following: aluminum 6201 T83 alloy, 6201 T81 alloy, aluminum 1350-H19 alloy, or a heat resistant aluminum-zirconium alloy; wherein the transmission cable has a low sag characteristic. The at least one electrical current source can be connected to the transmission cable, wherein electrical current is transmitted via the transmission cable.

In one aspect of an embodiment, each of the plurality of wires can have a cross-section profile shape which can include a trapezoid shape or a round shape.

In one aspect of an embodiment, each of the plurality of wires can include a trapezoid cross-section profile shape, and the wires are oriented to form a plurality of concentrically aligned layers of wires around the core.

In one aspect of an embodiment, the plurality of wires can include at least two concentrically aligned layers of wires around the core.

In one aspect of an embodiment, the plurality of concentrically aligned layers of wires around the core can include at least three layers.

In one aspect of an embodiment, the plurality of wires are helically wrapped around the core.

In one aspect of an embodiment, the low sag characteristic can be between approximately 40.0 and 48.0 feet (12.2-14.6 m) of sag with an ice thickness of approximately 1.25 inches (3.2 cm) on the transmission cable spanning about 1400 linear feet (426.7 m).

In one aspect of an embodiment, the low sag characteristic can be between approximately 63.0 feet (19.2 m) and 90.2 feet (27.5 m) of sag with an ice thickness of approximately 2.0 inches (5.1 cm) on the transmission cable spanning about 1400 linear feet (426.7 m).

Other systems, processes, apparatus, aspects, and features according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIG. 1 illustrates a cross-sectional view of an example conductor and transmission cable according to an embodiment of the invention.

FIG. 2 illustrates a side cutaway view of an example conductor and transmission cable according to an embodiment of the invention.

FIG. 3 illustrates an example transmission system according to an embodiment of the invention.

FIG. 4A illustrates a graphical comparison of the sag characteristic of one embodiment of the invention against two conventional conductors and transmission cables.

FIG. 4B illustrates a graphical comparison of a sag characteristic of several embodiments of the invention against two conventional conductors and transmission cables.

FIG. 5 illustrates a cross-sectional view of another example conductor and transmission cable according to an embodiment of the invention.

FIG. 6 illustrates a cross-sectional view of another example conductor and transmission cable according to an embodiment of the invention.

FIG. 7 illustrates a cross-sectional view of an example wire used for a conductor and transmission cable according to an embodiment of the invention.

FIG. 8 illustrates a cross-sectional view of another example wire used for a conductor and transmission cable according to an embodiment of the invention.

FIG. 9 illustrates a process diagram of an example method for making a conductor and transmission cable according to one embodiment of the invention.

FIG. 10 illustrates a flowchart of an example method for using a conductor and transmission cable according to one embodiment of the invention.

### DETAILED DESCRIPTION OF EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

The terms “conductor” and “transmission cable” and their pluralized forms are used interchangeably herein to refer to the electrical wire structure with a core wrapped with one or more respective wires in accordance with an embodiment of the invention.

The terms “sag” and “sag characteristic” are used interchangeably herein to refer to a physical or mechanical property of the conductor and transmission cable exhibited when the conductor and transmission cable spans between two locations. For example, the sag or sag characteristic of a conductor or transmission cable can be measured by the vertical deflection of the cable between the two locations over the distance or span between the locations. By way of further example, the phrases “low sag performance” and “improved sag performance” describe instances when the sag in a conductor and transmission cable are decreased or otherwise improved over a conventional conductor and transmission cable.

Certain embodiments of the invention generally provide for an aluminum alloy conductor composite reinforced for high voltage overhead power lines and associated methods of use and manufacture. Because an aluminum alloy conductor composite reinforced for high voltage overhead power lines can be implemented, using systems, methods, and apparatus according to embodiments of the invention can result in improved sag performance and reduced maintenance and repair costs. Furthermore, technical effects by certain embodiments of the invention can result such as the ability to withstand certain loads caused by ice conditions. One should appreciate that certain embodiments of the invention can be used in other environments, contexts, and applications, and should not be limited to power transmission cable applications or applications, but should include non-power transmission cable applications and applications in which one or more wires or conductors are connected to each other.

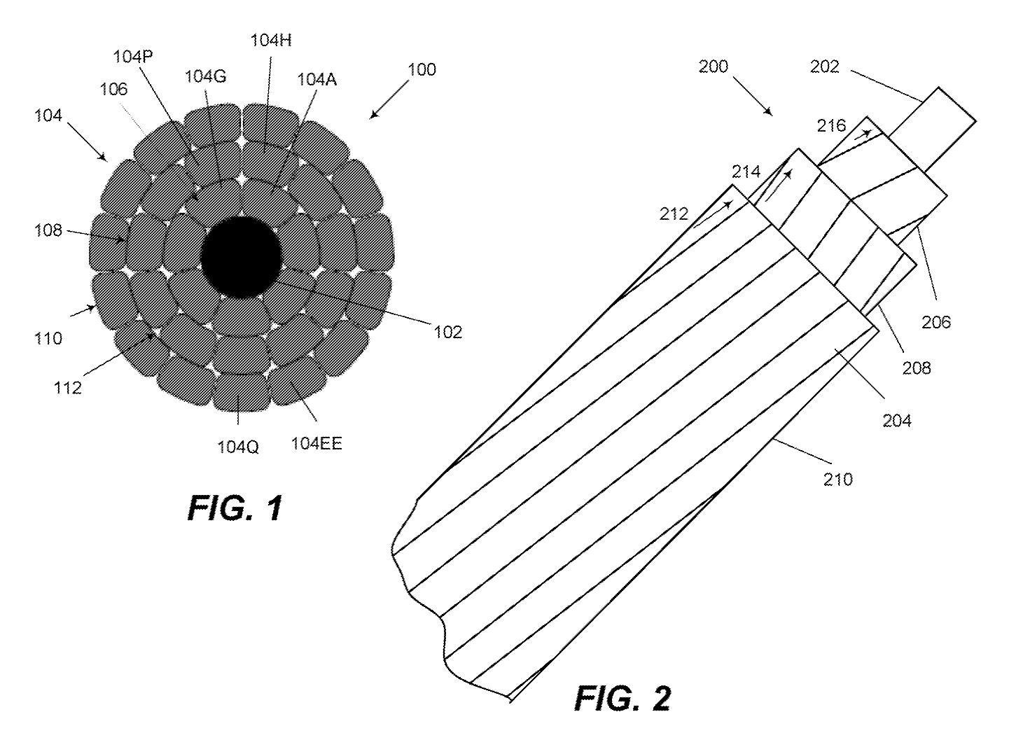

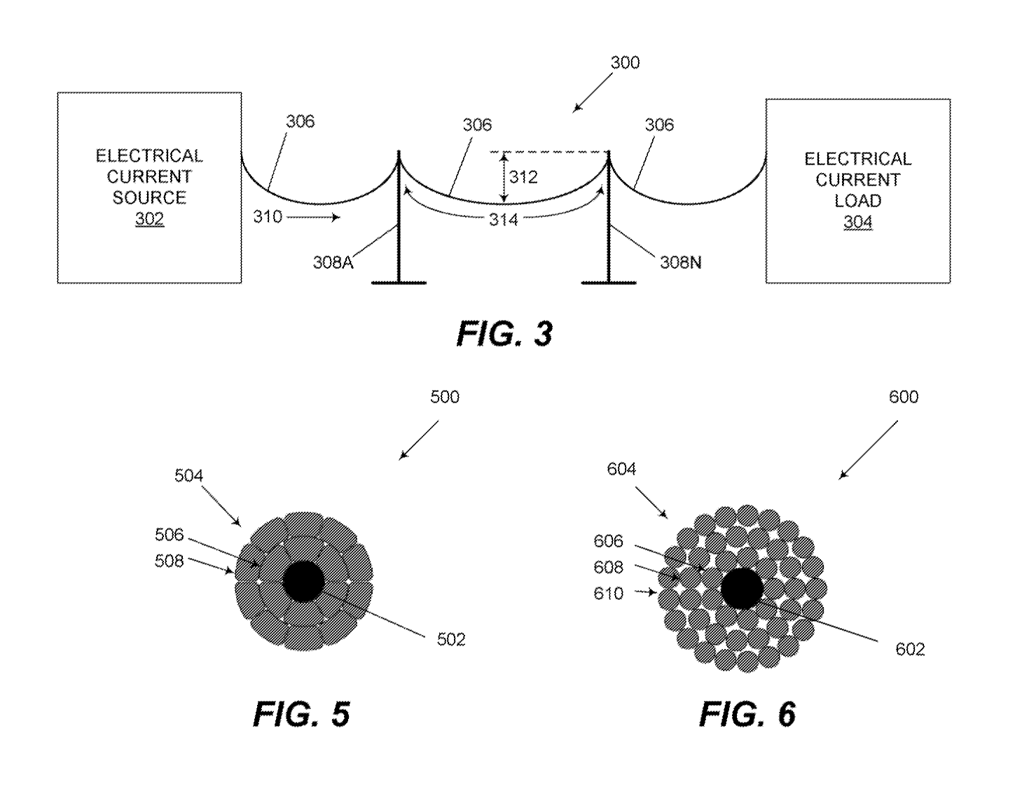

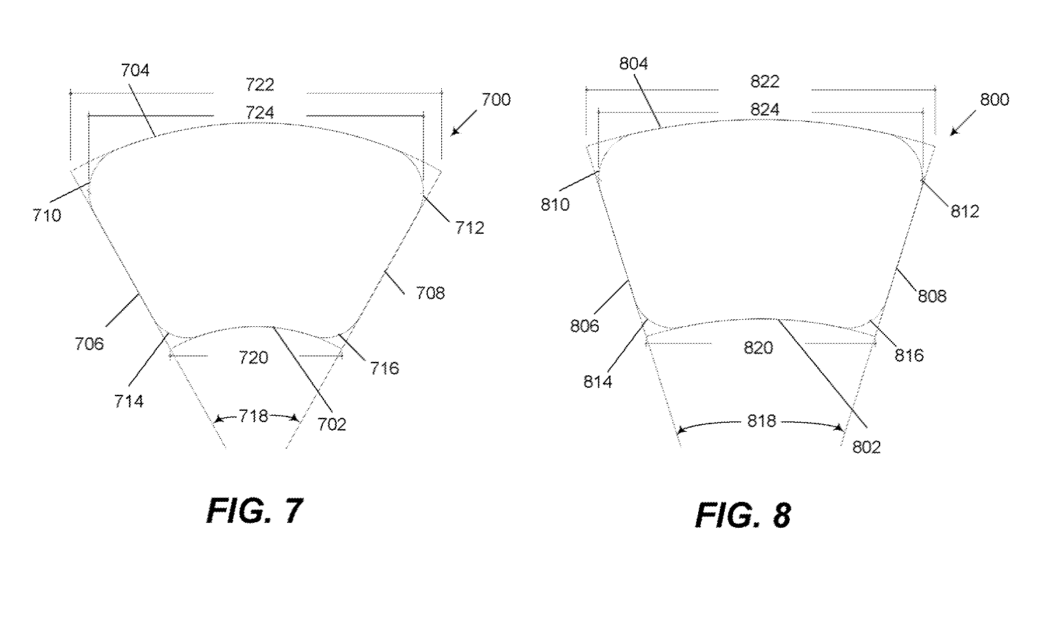

FIG. 1 illustrates a cross-sectional view of an example conductor and transmission cable according to an embodiment of the invention. As shown in FIG. 1, an example conductor 100 can include a core 102 with one or more wires 104 wrapped around the core 102. The core 102 shown can have a relatively circular cross-sectional shape. Each of the wrapped wires 104 shown can have a relatively trapezoidal shape similar to the trapezoidal-shaped cross-sections shown and described in FIGS. 7 and 8. The example conductor 100 shown in FIG. 1 can be used as a conductor and transmission cable for a transmission system, an example of which is shown respectively as 200 and 300 in FIGS. 2 and 3.

The wrapped wires 104 in the embodiment shown in FIG. 1 can be oriented in three concentric layers 106, 108, 110 around the core 102. A first or inner concentric layer 106 can include six wires 104A-104F, each of which is in relative close proximity or otherwise adjacent to an outer surface of the core 102, and in close proximity to at least two adjacent wires of the same concentric layer 106. A second or intermediate concentric layer 108 can include ten wires 104G-104P, each of which is in relative close proximity or otherwise adjacent to an outer surface of one or more wires of the first or inner concentric layer 106, and in close proximity to at least two adjacent wires of the second or intermediate concentric layer 108. A third or outer concentric layer 110 can include fifteen wires 104Q-104FF, each of which is in relative close proximity or otherwise adjacent to an outer surface of one or more wires of the second or intermediate layer 108, and in relative close proximity or otherwise adjacent to at least two adjacent wires of the third or outer concentric layer 110.

Between each of the adjacent wires 104, particularly near the corners of each trapezoidal-shape, one or more relatively small spaces 112 can exist where adjacent wires 104 do not coincide or otherwise contact each layer. One aspect of an embodiment of the invention is to provide a relatively compact cross-section while maximizing the cross-section of each respective wire and permitting the overall conductor structure the ability to flex as needed.

The core 102 shown in FIG. 1 can be a composite core material, such as the composite core used in the conductor sold under the mark ACCC® by Composite Technology Cable (CTC) Corporation of Irvine, Calif., United States. In another embodiment, a core can be a plurality of fibers in a matrix of one or more materials. In yet another embodiment, a core can be a set of carbon fibers embedded in an epoxy matrix. Other suitable cores for use with a conductor and transmission cable in accordance with embodiments of the invention are described in U.S. Pat. Nos. 7,211,319 and 7,368,162. For example, suitable matrix materials for a core can include, but are not limited to, any type of organic or inorganic material that can embed and bundle a plurality of fibers into a composite core, glue, ceramics, metal matrices, resins, epoxies, foams, elastomers, or polymers. By way of further example, suitable fiber materials can include, but are not limited to, glass, glass-type, carbon (graphite), carbon-type, Kevlar, basalt, Aramid, boron, liquid crystal, high performance polyethylene, carbon nanofibers or nanotubes. One will recognize that other materials can be used as matrix and fiber materials for a composite core in accordance with embodiments of the invention. Furthermore, one will recognize that the manufacturing methods described in U.S. Pat. Nos. 7,211,319 and 7,368,162 can be suitable for making core in accordance with embodiments of the invention.

The one or more wires 104 wrapped around the core 102 can be made from an aluminum 6201 T83 alloy, such as the alloy sold under the trademark ARVIDAL™ by the Alcan Cable Corporation of Atlanta, Ga., United States. In another embodiment, one or more wire can be made from an aluminum 6201 T81 alloy or an aluminum 6201 T81 alloy meeting an ASTM standard. In another embodiment, one or more wires can be made from an aluminum 1350-H19 alloy or an aluminum 1350-H19 alloy meeting ASTM B 230. In yet another embodiment, one or more wires can be made from a heat resistant aluminum-zirconium alloy or a heat resistant aluminum-zirconium alloy meeting ASTM B941.

In any instance, using a combination of materials described above for the core 102 and the wires 104 wrapped around the core 102, the resulting conductor and transmission cable can have a relatively low or improved sag characteristic. The sag performance improvement is believed to result from the combination and use of materials that reduce the loading or transfer of weight to the composite core, which was one drawback of conventional conductors and transmission cables. One technical effect of an embodiment of the invention can be the reduction of sag in the conductor or associated transmission cable due to the weight of the conductor or cable itself, and in particular, when ice or water collects on the conductor or associated transmission cable when used in overhead power lines. This technical effect can decrease operating costs. For instance, transmission cable spans can be increased and/or transmission cable support structures or towers can be made shorter to appease land owners, who may decide whether to grant easements or permission for the construction and operation of overhead power transmission lines across their property. Another technical effect of an embodiment of the invention can be a conductor and transmission cable with a combination of relatively low operating temperature with the low sag characteristic. For example, one embodiment of a conductor and transmission cable can operate continuously up to about 203 degrees F. (95 degrees C.) with a low sag characteristic of between approximately 40.0 to 48.0 (12.2-14.6 m) of sag with an ice thickness of approximately 1.25 inches (3.2 cm) on the transmission cable about 1400 linear feet (426.7 m). In another example, an embodiment of a conductor and transmission cable can operate continuously up to about 203 degrees F. (95 degrees C.) with a low sag characteristic of between approximately 63.0 feet (19.2 m) and 90.2 feet (27.5 m) of sag with an ice thickness of approximately 2.0 inches (5.1 cm) on the transmission cable spanning about 1400 linear feet (426.7 m). Yet another technical effect of an embodiment of the invention can be a conductor and transmission cable with increased resistance to surface scratching and damage to the conductor and transmission cable during installation. Such damage can lead to an electrical discharge or corona and further damage to the conductor and/or transmission cable. In certain instances, damage to the conductor and/or transmission cable may increase noise during power transmission operation that may be noticeable to nearby landowners or residents.

In one embodiment, each of the plurality of wires can have a cross-section profile shape of a trapezoid shape or a round shape.

In one embodiment, each of the plurality of wires can include a trapezoid cross-section profile shape, and the wires can be oriented to form a plurality of concentrically aligned layers of wires around the core.

In one embodiment, the plurality of wires can include at least two concentrically aligned layers of wires around the core.

In one embodiment, the plurality of concentrically aligned layers of wires around the core can include at least three layers.

In one embodiment, the plurality of wires can be helically wrapped around the core.

In one embodiment, the sag characteristic can be between approximately 40.0 and 48.0 feet (12.2-14.6 m) of sag with an ice thickness of approximately 1.25 inches (3.2 cm) on the transmission cable spanning about 1400 linear feet (426.7 m).

In one embodiment, the sag characteristic can be between approximately 63.0 feet (19.2 m) and 90.2 feet (27.5 m) of sag with an ice thickness of approximately 2.0 inches (5.1 cm) on the transmission cable spanning about 1400 linear feet (426.7 m).

In other embodiments, different shaped conductors, transmission cables, cores, and wires as well as different orientations of conductors, transmission cables, cores, and wires can be used in accordance with the invention. Further, different numbers of cores, wires, and concentric layers can be used in accordance with embodiments of the invention.

FIG. 2 illustrates a cutaway side view of an example conductor or transmission cable according to an embodiment of the invention. Similar to the conductor 100 shown in FIG. 1, the conductor 200 shown in FIG. 2 can include a composite core 202 with one or more wires 204 wrapped around the composite core 202. The composite core 202 shown can have a relatively circular cross-sectional shape. Each of the wrapped wires 204 shown can have a relatively trapezoidal shape. The wrapped wires form three concentric layers 206, 208, 210 around the composite core 202. As shown in FIG. 2, each of the wrapped wires 204 and concentric layers 206, 208, 210 are wrapped in a helical-configuration along the length of the composite core with each concentric layer wrapped in an opposing or different direction 212, 214, 216 than each adjacent concentric layer. In the view shown, and for convenience only, the three concentric layers 206, 208, 210 of wires 204 have been successively cut back to expose an external portion of the composite core 202 and each underlying concentric layer 206, 208.

In other embodiments, a different wrapping orientation for some or all of the concentric layers of wires can be used in accordance with the invention. In certain embodiments, the wrapped wires of alternating concentric layers may be wound in similar directions, as opposed to alternating opposing directions. In certain other embodiments, the wrapped wires of alternating concentric layers may be wound with fewer or greater revolutions per unit length than illustrated in FIG. 2.

FIG. 3 illustrates an example transmission system according to an embodiment of the invention. In this embodiment, a transmission system 300 can include an electrical current source 302, an electrical current load 304, at least one transmission cable 306 between the electrical current source 302 and the electrical current load 304. Typically, one or more transmission cable supports 308A, 308N can be spaced apart between the electrical current source 302 and the electrical current load 304, and can support at least a portion of the transmission cable 306 between the electrical current source 302 and the electrical current load 304. In the embodiment shown, a high voltage electrical current can be transmitted from the electrical current source 302 along the length of the transmission cable 306 in the direction 310 of and towards the electrical current load 304. As the transmission cable 306 extends between adjacent transmission cable supports 308A, 308N, the transmission cable 306 can sag between the supports 308A, 308N, wherein the sag can be measured by a vertical distance 312 over a length 314 or span of the transmission cable.

The electrical current source 302 shown in FIG. 3 can be a power generation or power transmission device operable to generate or otherwise transmit a relatively high voltage electrical current. For example, an electrical current source can be a generating step up transformer operable to generate an electrical current with a voltage of about 345 kV and above. In other embodiments, an electrical current source can generate electrical current with a lower or higher voltage.

The electrical current load 304 shown in FIG. 3 can be a power transmission device or electrically operated device operable to receive or otherwise use a relatively high voltage electrical current. For example, an electrical current source can be a substation step down transformer operable to receive an electrical current with a voltage of about 345 kV and above. In other embodiments, an electrical current load can receive or otherwise use an electrical current with a lower or higher voltage.

The transmission cable 306 shown in FIG. 3 can be similar to the conductors and transmission cables shown as 100 and 200 in FIGS. 1 and 2. For example, the transmission cable 306 can include a core including, but not limited to, a composite core, a plurality of fibers in a matrix of one or more materials, or a set of carbon fibers embedded in an epoxy matrix. By way of further example, the transmission cable 306 can include one or more wires helically wrapped around the core, wherein the one or more wires can include, but are not limited to, an aluminum 6201 T83 alloy, aluminum 6201 T81 alloy, an aluminum 1350-H19 alloy, or a heat resistant aluminum-zirconium alloy. In any instance, the transmission cable can have a relatively low sag characteristic.

In use, the transmission system 300 can provide high voltage electrical current from the electrical current source 302 to the electrical current load 304. When energized or otherwise transmitting high voltage electrical current during operation, the transmission cable 306 can withstand relatively heavy loads, such as ice or water, that may be present during operation.

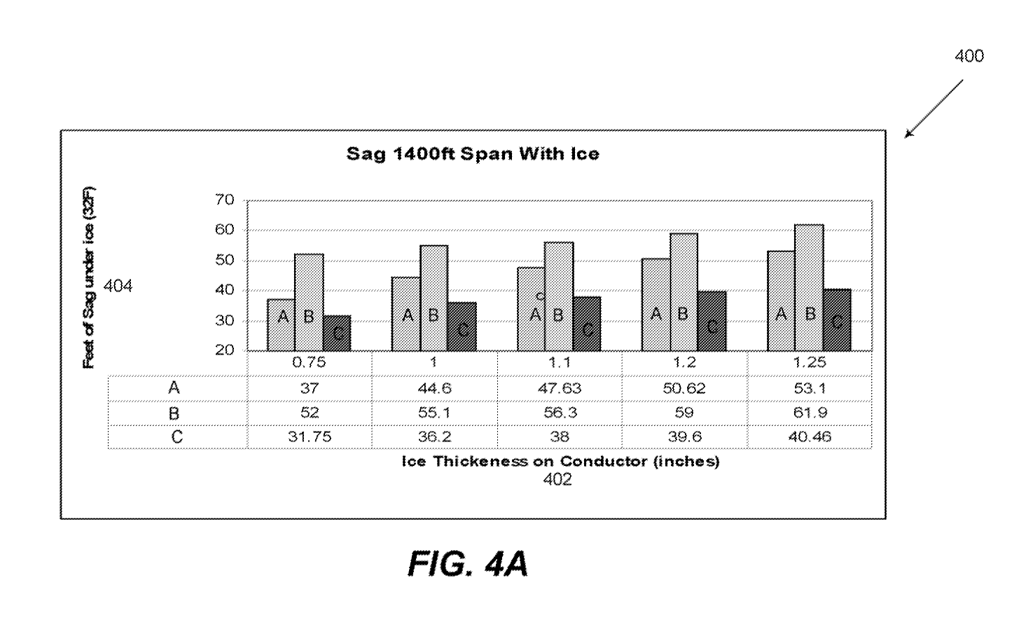

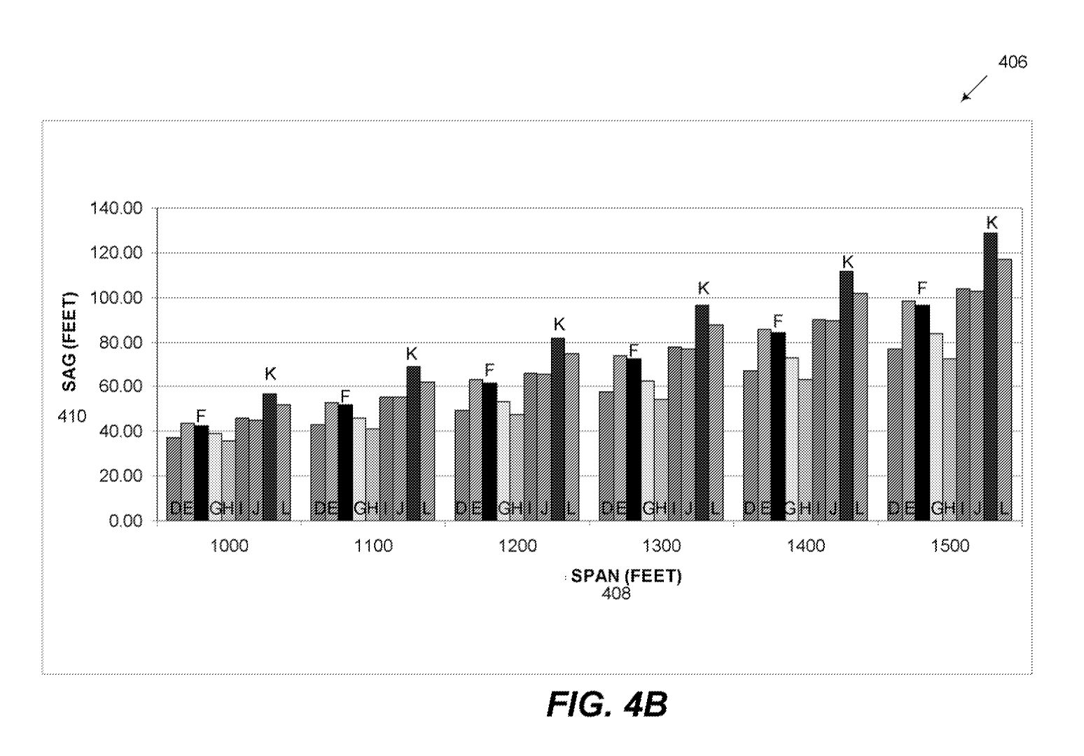

FIG. 4A illustrates a graphical comparison of the sag characteristic of one conductor and transmission cable embodiment of the invention against two conventional conductors and transmission cables. The table 400 in FIG. 4A shows example sag characteristics of three different conductors and transmission cables A, B, and C measured on the X axis 402 showing a range of ice thicknesses on the conductors and transmission cables measured in inches and on the Y-axis 404 showing the sag measured in feet. A and B are example conventional conductors and transmission cables, and C is an example conductor and transmission cable in accordance with an embodiment of the invention. The sag characteristic in this example comparison was made over about 1400 feet (426.7 m) of span for each tested conductor and transmission cable for a range of different ice thicknesses at 32 degrees Fahrenheit (0 degrees C.). The different ice thicknesses tested were 0.75 inches (1.90 cm), 1.0 inches (2.5 cm), 1.1 inches (2.8 cm), 1.2 inches (3.0 cm), and 1.25 inches (3.2 cm).

In the first example, with an ice thickness or loading of 0.75 inches (1.90 cm) and over a span of about 1400 feet, conductor and transmission cable A had a sag of about 37 feet (11.3 m), conductor and transmission cable B had a sag of about 52 feet (15.8 m), and conductor and transmission cable C had a sag of about 31.75 feet (9.68 m). In another example, with an ice thickness or loading of 1.0 inches (2.5 cm) and over a span of about 1400 feet (426.7 m), conductor and transmission cable A had a sag of about 44.6 feet (13.6 m), conductor and transmission cable B had a sag of about 55.1 feet (16.8 m), and conductor and transmission cable C had a sag of about 36.2 feet (11.0 m). In another example, with an ice thickness or loading of 1.1 inches (2.8 cm) and over a span of about 1400 feet (426.7 m), conductor and transmission cable A had a sag of about 47.63 feet (14.52 m), conductor and transmission cable B had a sag of about 56.3 feet (17.2 m), and conductor and transmission cable C had a sag of about 38 feet (11.6 m). In another example, with an ice thickness or loading of 1.2 inches (3.0 cm) and over a span of about 1400 feet (426.7 m), conductor and transmission cable A had a sag of about 50.62 feet (15.43 m), conductor and transmission cable B had a sag of about 59 feet (18.0 m), and conductor and transmission cable C had a sag of about 39.6 feet (12.1 m). In yet another example, with an ice thickness or loading of 1.25 inches (3.2 cm) and over a span of about 1400 feet (426.7 m), conductor and transmission cable A had a sag of about 53.1 feet (16.2 m), conductor and transmission cable B had a sag of about 61.9 feet (18.9 m), and conductor and transmission cable C had a sag of about 40.46 feet (12.33 m).

As shown in FIG. 4A, the conductor and transmission cable C exhibits decreased sag or less sag than the conventional conductors and transmission cables A, B over a range of ice thicknesses for about the same span or length. As discussed above, the various technical effects of certain embodiments of the invention can decrease operating costs, can offer improved operating characteristics, and can improve resistance to scratching and damage.

FIG. 4B illustrates a graphical comparison of a sag characteristic of several embodiments of the invention against two conventional conductors and transmission cables. The table 406 in FIG. 4B shows example sag characteristics of seven different conductors and transmission cables D, E, F, G, H, I and J measured on the X axis 408 showing a range of ruling spans for conductors and transmission cables measured in feet from 1000 to 1500 feet, and on the Y-axis 410 showing the sag measured in feet. K and L are example conventional conductors and transmission cables, and D, E, F, G, H, I and J are example conductors and transmission cables in accordance with an embodiment of the invention. The sag characteristics in this example comparison were made with 2.0 inches (5.1 cm) ice loading on the transmission cables at spans of 1000 feet (304.8 m), 1100 feet (335.3 m), 1200 feet (365.8 m), 1300 feet (396.2 m), 1400 feet (426.7 m), and 1500 feet (457.2 m) for each tested conductor and transmission cable.

By way of example, with an ice thickness or loading of 2.0 inches (5.1 cm) and over a span of about 1000 feet (304.8 m), conductors and transmission cables D, E, F, G, H, I, J had sags in a range between about 36.9 to 45.9 feet (11.2-14.0 m) compared to conventional conductors and transmission cables K, L with sags of about 56.82 feet (17.32 m) and 51.76 feet (15.78 m), respectively. In another example, with an ice thickness or loading of 2.0 inches (5.1 cm) and over a span of about 1100 feet (335.3 m), conductors and transmission cables D, E, F, G, H, I, J had sags in a range between about 41.2 to 55.6 feet (12.6-16.9 m) compared to conventional conductors and transmission cables K, L with sags of about 68.82 feet (20.98 m) and 62.28 feet (18.98 m), respectively. In another example, with an ice thickness or loading of 2.0 inches (5.1 cm) and over a span of about 1200 feet (365.8 m), conductors and transmission cables D, E, F, G, H, I, J had sags in a range between about 47.2 to 66.2 feet (14.4-20.2 m) compared to conventional conductors and transmission cables K, L with sags of about 81.98 feet (24.99 m) and 74.66 feet (22.76 m), respectively. In another example, with an ice thickness or loading of 2.0 inches (5.1 cm) and over a span of about 1300 feet (396.2 m), conductors and transmission cables D, E, F, G, H, I, J had sags in a range between about 54.3 to 77.7 feet (16.6-23.7 m) compared to conventional conductors and transmission cables K, L with sags of about 96.31 feet (29.36 m) and 87.7 feet (26.7 m), respectively. In yet another example, with an ice thickness or loading of 2.0 inches (5.1 cm) and over a span of about 1400 feet (426.7 m), conductors and transmission cables D, E, F, G, H, I, J had sags in a range between about 63.01 to 90.18 feet (19.21-27.49 m) compared to conventional conductors and transmission cables K, L with sags of about 111.83 feet (34.09 m) and 101.8 feet (31.0 m), respectively. In yet another example, with an ice thickness or loading of 2.0 inches (5.1 cm) and over a span of about 1500 feet (457.2 m), conductors and transmission cables D, E, F, G, H, I, J had sags in a range between about 72.36 to 103.60 feet (22.06-31.58 m) compared to conventional conductors and transmission cables K, L with sags of about 128.53 feet (39.18 m) and 116.99 feet (35.66 m), respectively.

As shown in FIG. 4B, the conductors and transmission cables D, E, F, G, H, I, J exhibit decreased sag or less sag than the conventional conductors and transmission cables K, L over a range of spans for about the same ice thickness or ice loading. As discussed above, the various technical effects of certain embodiments of the invention can decrease operating costs, can offer improved operating characteristics, and can improve resistance to scratching and damage.

FIGS. 5-6 illustrate other example conductors and transmission cable configurations according to embodiments of the invention. FIG. 5 illustrates one example conductor and transmission cable configuration with two concentric layers of trapezoidal-shaped wires surrounding a core, and FIG. 6 illustrates another example conductor and transmission cable configuration with three concentric layers of round-shaped wires surrounding a core, both in accordance with embodiments of the invention. One will recognize that the dimensions for the round-shaped cross-sections can vary depending on factors including, but not limited to, the size of the core, the number of wires in each concentric layer, the number of concentric layers, the overall outer diameter of the conductor and transmission cable, and any spaces between adjacent wires, particularly between each round-shape wire, such as 112 in FIG. 1.

As shown in FIG. 5, an example conductor and transmission cable 500 can include a core 502 with a plurality of trapezoidal-shaped wires 504 in two concentric layers 506, 508 wrapped around the core 502. The embodiment of FIG. 5 is similar to the embodiment shown in FIG. 1 without the third concentric layer 110 of wires. The first or inner concentric layer 506 can include 6 trapezoidal-shaped wires, and the second or outer concentric layer 508 can include 10 trapezoidal-shaped wires. Example cross-sections and dimensions for the trapezoidal-shaped wires are shown in FIGS. 7 and 8 described below. The core 502 can generally be round shaped, for instance, a composite core used in the conductor sold under the mark ACCC® by Composite Technology Cable (CTC) Corporation of Irvine, Calif., United States, and the wires 504 can be made from aluminum 6201 T83 alloy. Similar to the embodiments shown in FIGS. 1 and 2, the wires 504 and concentric layers 506, 508 can be helically wrapped around the core 502, with each layer 506, 508 wrapped in opposing or different directions to each other.

By way of example only, the example conductor and transmission cable shown in FIG. 5 can have dimensions of about 1.00 inches (2.5 cm) OD (outside diameter) with a total cross-sectional area of about 0.7523 square inches (4.854 square cm) and a linear weight of about 0.864 pounds per foot (1.286 kg/m). The core 502 can have an OD (outside diameter) of about 0.3050 inches (0.774 cm) with a cross-sectional area of about 0.0731 square inches (0.4716 square cm), and the wires 504 can each have a cross-sectional area of about 0.0424 square inches (0.1181 square cm) and have a collective cross-sectional area of about 0.9422 square inches (6.079 square cm).

By way of further example, another example conductor and transmission cable with a shape and configuration similar to FIG. 5 can include wires 504 made from a heat resistant aluminum-zirconium alloy. The dimensions of the example conductor and transmission cable can be about 1.18 inches (3.0 cm) OD (outside diameter) with a total cross-sectional area of about 1.0153 square inches (6.5503 square cm) and a linear weight of about 1.181 pounds per foot (1.758 kg/m). The core 502 in this example can have an OD (outside diameter) of about 0.375 inches (0.953 cm) with a cross-sectional area of about 0.1104 square inches (0.7123 square cm), and the wires 504 in this example can each have a cross-sectional area of about 0.0286 square inches (0.1845 square cm) and have a collective cross-sectional area of about 0.9422 square inches (6.079 square cm).

By way of further example, another example conductor and transmission cable with a shape and configuration similar to FIG. 5 can include wires 504 made from an aluminum 1350 H19 alloy. The dimensions of the example conductor and transmission cable can be about 1.18 inches (3.0 cm) OD (outside diameter) with a total cross-sectional area of about 1.0153 square inches (6.5503 square cm) and a linear weight of about 1.870 pounds per foot (2.783 kg/m). The core 502 in this example can have an OD (outside diameter) of about 0.375 inches (0.953 cm) with a cross-sectional area of about 0.1104 square inches (0.7123 square cm), and the wires 504 in this example can each have a cross-sectional area of about 0.0286 square inches (0.1842 square cm) and have a collective cross-sectional area of about 0.9422 square inches (6.079 square cm).

As shown in FIG. 6, another example conductor and transmission cable 600 can include a core 602 with a plurality of round-shaped wires 604 in three concentric layers 606, 608, 610 wrapped around the core 602. The embodiment of FIG. 6 is similar to the embodiment shown in FIG. 1 but the wires 604 are round-shaped instead of trapezoidal-shaped. The first or inner concentric layer 606 can include 9 round-shaped wires, the second or intermediate concentric layer 608 can include 15 round-shaped wires, and third or outer concentric layer 610 can include 21 round-shaped wires. The core 602 can generally be round shaped, for instance, a composite core used in the conductor sold under the mark ACCC® by Composite Technology Cable (CTC) Corporation of Irvine, Calif., United States, and the wires 604 can be made from aluminum 6201 T83 alloy. Similar to the embodiments shown in FIGS. 1, 2, and 5, the wires 604 and concentric layers 606, 608, 610 can be helically wrapped around the core 602, with each layer 606, 608, 610 wrapped in opposing or different directions to the adjacent concentric layer.

By way of example only, the example conductor and transmission cable shown in FIG. 6 can have dimensions of about 1.22 inches (3.10 cm) OD (outside diameter) with a total cross-sectional area of about 0.8950 square inches (5.774 square cm) and a linear weight of about 1.037 pounds per foot (1.544 kg/m). The core 602 can have an OD (outside diameter) of about 0.3050 inches (0.774 cm) with a cross-sectional area of about 0.0731 square inches (0.4716 square cm), and the wires 604 can each have a cross-sectional area of about 0.0183 square inches (0.274 square cm) and have a collective cross-sectional area of about 0.8219 square inches (5.033 square cm).

By way of further example, another example conductor and transmission cable with a shape and configuration similar to FIG. 6 can include wires 604 made from an aluminum 6201 T81 alloy. The dimensions of the example conductor and transmission cable can be about 1.22 inches (3.10 cm) OD (outside diameter) with a total cross-sectional area of about 0.8950 square inches (5.774 square cm) and a linear weight of about 1.037 pounds per foot (1.544 kg/m). The core 602 can have an OD (outside diameter) of about 0.3050 inches (0.774 cm) with a cross-sectional area of about 0.0731 square inches (0.4716 square cm), and the wires 604 can each have a cross-sectional area of about 0.0183 square inches (0.274 square cm) and have a collective cross-sectional area of about 0.8219 square inches (5.033 square cm).

By way of example only, another example conductor and transmission cable with a shape and configuration similar to FIG. 6 can include wires 604 made from a heat resistant aluminum-zirconium alloy. The dimensions of the example conductor and transmission cable can be about 1.22 inches (3.10 cm) OD (outside diameter) with a total cross-sectional area of about 0.8950 square inches (5.774 square cm) and a linear weight of about 1.037 pounds per foot (1.544 kg/m). The core 602 can have an OD (outside diameter) of about 0.3050 inches (0.774 cm) with a cross-sectional area of about 0.0731 square inches (0.4716 square cm), and the wires 604 can each have a cross-sectional area of about 0.0183 square inches (0.274 square cm) and have a collective cross-sectional area of about 0.8219 square inches (5.033 square cm).

By way of example only, another example conductor and transmission cable with a shape and configuration similar to FIG. 6 can include wires 604 made from an aluminum 1350 H19 alloy. The dimensions of the example conductor and transmission cable can be about 1.22 inches (3.10 cm) OD (outside diameter) with a total cross-sectional area of about 0.8950 square inches (5.774 square cm) and a linear weight of about 1.042 pounds per foot (1.550 kg/m). The core 602 can have an OD (outside diameter) of about 0.3050 inches (0.774 cm) with a cross-sectional area of about 0.0731 square inches (0.4716 square cm), and the wires 604 can each have a cross-sectional area of about 0.0183 square inches (0.274 square cm) and have a collective cross-sectional area of about 0.8219 square inches (5.033 square cm).

FIGS. 7 and 8 illustrate cross-sectional views of example wires used for conductors and transmission cables according to embodiments of the invention. One will recognize that the dimensions for the trapezoidal-shaped cross-sections can vary depending on factors including, but not limited to, the size of the core, the number of wires in each concentric layer, the number of concentric layers, the overall outer diameter of the conductor and transmission cable, and any spaces between adjacent wires, particularly near the corners of each trapezoidal-shape wire, such as 112 in FIG. 1.

FIG. 7 illustrates a cross-sectional view of an example wire used for a conductor and transmission cable according to an embodiment of the invention. In the embodiment shown in FIG. 7, the wire 700 can be used in a first or inner concentric layer around a core, such as inner concentric layer 106 in FIG. 1. The wire 700 can have a trapezoidal-shape with a relatively shorter inner surface 702, a relatively longer outer surface 704, and a pair of lateral surfaces 706, 708 extending between the inner surface 702 and outer surface 704. Each of the corners 710, 712, 714, 716 between the adjacent surfaces 702, 704, 706, 708 can be generally rounded or otherwise tapered. The arc width 718 between lateral surfaces 706, 708 can be about 58 degrees and 37.90 arcminutes.

By way of example only, the example wire 700 shown in FIG. 7 can have dimensions of about 0.1493 inches (3.792 mm) horizontal distance 720 between points on the arc width defining the inner surface 702, about 0.3228 inches (8.199 mm) horizontal distance 722 between points on the arc width defining outer surface 704, and about 0.2911 inches (7.394 mm) horizontal distance 724 between the upper corners 710, 712 of the wire 700 at the widest point between the lateral surfaces 706, 708.

FIG. 8 illustrates another cross-sectional view of an example wire used for a conductor and transmission cable according to an embodiment of the invention. In the embodiment shown in FIG. 8, the wire 800 can be used in a second or intermediate concentric layer around a core, such as intermediate concentric layer 108 in FIG. 1. The wire 800 can have a trapezoidal-shape with a relatively shorter inner surface 802, a relatively longer outer surface 804, and a pair of lateral surfaces 806, 808 extending between the inner surface 802 and outer surface 804. Each of the corners 810, 812, 814, 816 between the adjacent surfaces 802, 804, 806, 808 can be generally rounded or otherwise tapered. The arc width 818 between lateral surfaces 806, 808 can be about 34 degrees and 56.33 arcminutes.

By way of example only, the example wire 800 shown in FIG. 8 can have dimensions of about 0.1979 inches (5.027 mm) horizontal distance 820 between points on the arc width defining the inner surface 802, about 0.3013 inches (7.653 mm) horizontal distance 822 between points on the arc width defining outer surface 804, and about 0.2800 inches (7.112 mm) horizontal distance 824 between the upper corners 810, 812 of the wire 800 at the widest point between the lateral surfaces 806, 808.

It will be recognized that other conductors, transmission cables, systems, and apparatus embodiments in accordance with the invention can include fewer or greater numbers of components and may incorporate some or all of the functionality described with respect to the conductors, transmission cables, systems, and apparatus shown in FIGS. 1-8.

One may recognize the applicability of these conductors, transmission cables, systems, and apparatus in certain embodiments of the invention to other environments, contexts, and applications. One will appreciate that the conductors, transmission cables, systems, and apparatus shown in and described with respect to FIGS. 1-8 are provided by way of example only. Numerous other operating environments, conductors, transmission cables, systems, and apparatus are possible using these or similar conductor, transmission cable, system, and apparatus components. Accordingly, these conductor, transmission cable, system, and apparatus components should not be construed as being limited to any particular operating environment, conductor, transmission cable, system, and apparatus configuration.

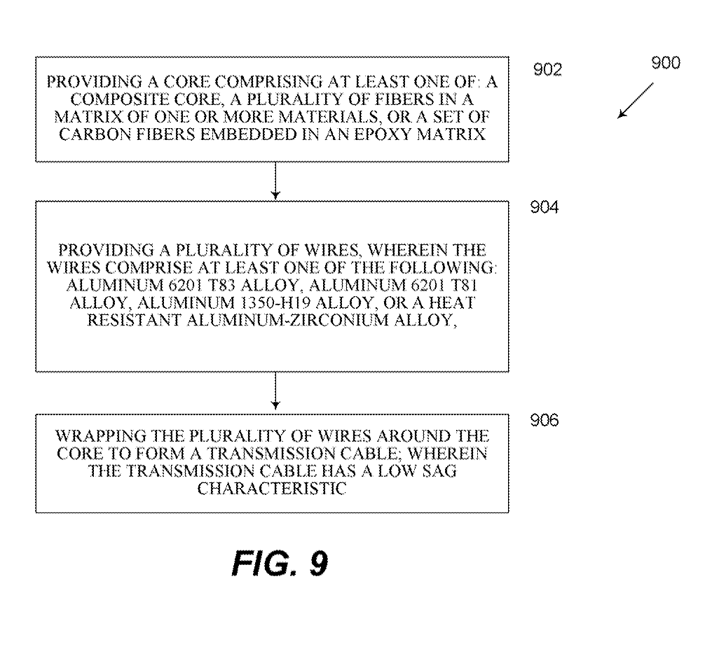

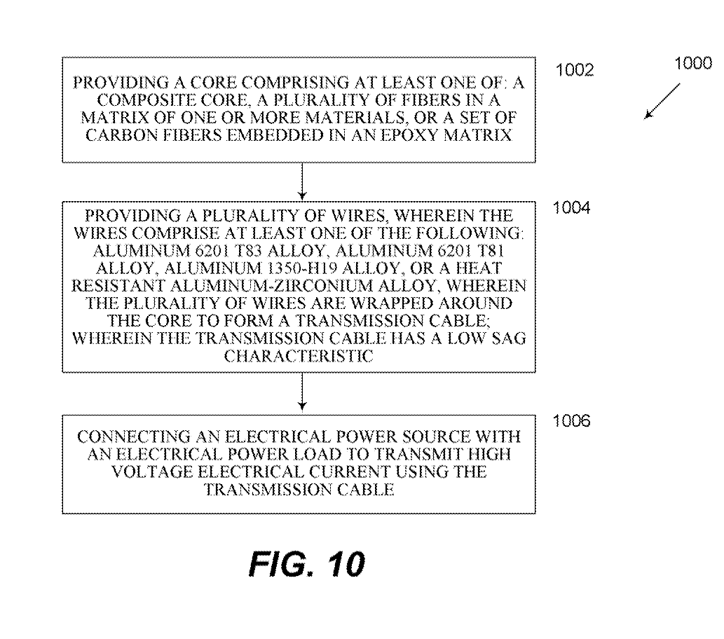

Example methods and processes which can be implemented with the example conductors, transmission cables, systems, and apparatus of FIGS. 1-8 are described by reference to FIGS. 9 and 10. FIG. 9 illustrates a process diagram of an example method 900 for making a conductor and transmission cable according to one embodiment of the invention. The flowchart 1000 described in FIG. 10 is a method for using a conductor and transmission cable according to one embodiment of the invention.

The method 900 in FIG. 9 begins at block 902, wherein a core is provided, wherein the core comprises at least one of: a composite core, a plurality of fibers in a matrix of one or more materials, or a set of carbon fibers embedded in an epoxy matrix.

Block 902 is followed by block 904, in which a plurality of wires is provided, wherein the wires can include at least one of the following: aluminum 6201 T83 alloy, aluminum 6201 T81 alloy, aluminum 1350-H19 alloy, or a heat resistant aluminum-zirconium alloy.

In one aspect of an embodiment, each of the plurality of wires can have a cross-section profile shape which can include a trapezoid shape or a round shape.

In one aspect of an embodiment, each of the plurality of wires can include a trapezoid cross-section profile shape, and the wires are oriented to form a plurality of concentrically aligned layers of wires around the core.

In one aspect of an embodiment, the plurality of wires can include at least three concentrically aligned layers of wires around the core.

In one aspect of an embodiment, the plurality of concentrically aligned layers of wires around the core can include at least three layers.

In one aspect of an embodiment, the low sag characteristic can be between approximately 40.0 and 48.0 feet (12.2-14.6 m) of sag with an ice thickness of approximately 1.25 inches (3.2 cm) on the transmission cable spanning about 1400 linear feet (426.7 m).

In one aspect of an embodiment, the low sag characteristic can be between approximately 63.0 feet (19.2 m) and 90.2 feet (27.5 m) of sag with an ice thickness of approximately 2.0 inches (5.1 cm) on the transmission cable spanning about 1400 linear feet (426.7 m).

In one aspect of an embodiment, wrapping the plurality of wires around the core to form a transmission cable can include helically wrapping the plurality of wires around the core.

Block 904 is followed by block 906, in which the plurality of wires are wrapped around the core to form a transmission cable; and wherein the transmission cable has a low sag characteristic.

After block 906, the method 900 ends.

Turning to FIG. 10, the method 1000 begins at block 1002, wherein a core is provided, wherein the core comprises at least one of: a composite core, a plurality of fibers in a matrix of one or more materials, or a set of carbon fibers embedded in an epoxy matrix.

Block 1002 is followed by block 1004, in which a plurality of wires is provided, wherein the wires can include at least one of the following: aluminum 6201 T83 alloy, aluminum 6201 T81 alloy, aluminum 1350-H19 alloy, or a heat resistant aluminum-zirconium alloy; wherein the plurality of wires are wrapped around the core to form a transmission cable; and wherein the transmission cable has a low sag characteristic.

In one aspect of an embodiment, each of the plurality of wires can have a cross-section profile shape which can include a trapezoid shape or a round shape.

In one aspect of an embodiment, each of the plurality of wires can include a trapezoid cross-section profile shape, and the wires are oriented to form a plurality of concentrically aligned layers of wires around the core.

In one aspect of an embodiment, the plurality of wires can include at least three concentrically aligned layers of wires around the core.

In one aspect of an embodiment, the plurality of concentrically aligned layers of wires around the core can include at least three layers.

In one aspect of an embodiment, the low sag characteristic can be between approximately 40.0 feet and 48.0 feet (12.2-14.6 m) of sag with an ice thickness of approximately 1.25 inches (3.2 cm) on the transmission cable spanning about 1400 linear feet (426.7 m).

In one aspect of an embodiment, the low sag characteristic can be between approximately 63.0 feet (19.2 m) and 90.2 feet (27.5 m) of sag with an ice thickness of approximately 2.0 inches (5.1 cm) on the transmission cable spanning about 1400 linear feet (426.7 m).

In one aspect of an embodiment, wrapping the plurality of wires around the core to form a transmission cable can include helically wrapping the plurality of wires around the core.

Block 1004 is followed by block 1006, in which an electrical power source is connected with an electrical power load to transmit high voltage electrical current using the transmission cable.

After block 1006, the method 1000 ends.

Additionally, it is to be recognized that, while the invention has been described above in terms of one or more embodiments, it is not limited thereto. Various features and aspects of the above described invention may be used individually or jointly. Although the invention has been described in the context of its implementation in certain environments and for certain purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every element described and illustrated need be performed. Accordingly, the claims set forth below should be construed in view of the full breadth of the embodiments as disclosed herein.

The claimed invention is:

1. A transmission cable comprising:
a core comprising at least one of: a composite core, a plurality of fibers in a matrix of one or more materials, or a set of carbon fibers embedded in an epoxy matrix; and
a plurality of wires wrapped around the core, wherein the wires comprise at least one of the following: aluminum 6201 T83 alloy, 6201 T81 alloy, aluminum 1350-H19 alloy, or a heat resistant aluminum-zirconium alloy;
wherein the transmission cable has a low sag characteristic.

2. The cable of claim 1, wherein each of the plurality of wires has a cross-section profile shape comprising: a trapezoid shape or a round shape.

3. The cable of claim 1, wherein each of the plurality of wires comprises a trapezoid cross-section profile shape, and the wires are oriented to form a plurality of concentrically aligned layers of wires around the core.

4. The cable of claim 1, wherein the plurality of wires comprises at least two concentrically aligned layers of wires around the core.

5. The cable of claim 3, wherein the plurality of concentrically aligned layers of wires around the core comprises at least three layers.

6. The cable of claim 1, wherein the plurality of wires are helically wrapped around the core.

7. The cable of claim 1, wherein the low sag characteristic is approximately 63.0 feet (19.2 m) and 90.2 feet (27.5 m) of sag with an ice thickness of approximately 2.0 inches (5.1 cm) on the transmission cable spanning about 1400 linear feet (426.7 m).

8. A method for making a transmission cable, the method comprising:
providing a core comprising at least one of: a composite core, a plurality of fibers in a matrix of one or more materials, or a set of carbon fibers embedded in an epoxy matrix; and
providing a plurality of wires, wherein the wires comprise at least one of the following: aluminum 6201 T83 alloy, 6201 T81 alloy, aluminum 1350-H19 alloy, or a heat resistant aluminum-zirconium alloy; and
wrapping the plurality of wires around the core to form a transmission cable;
wherein the transmission cable has a low sag characteristic.

9. The method of claim 8, wherein each of the plurality of wires has a cross-section profile shape comprising: a trapezoid shape or a round shape.

10. The method of claim 8, wherein each of the plurality of wires comprises a trapezoid cross-section profile shape, and the wires are oriented to form a plurality of concentrically aligned layers of wires around the core.

11. The method of claim 8, wherein the plurality of wires comprises at least three concentrically aligned layers of wires around the core.

12. The method of claim 10, wherein the plurality of concentrically aligned layers of wires around the core comprises at least three layers.

13. The method of claim 8, wherein the low sag characteristic is approximately 63.0 feet (19.2 m) and 90.2 feet (27.5 m) of sag with an ice thickness of approximately 2.0 inches (5.1 cm) on the transmission cable spanning about 1400 linear feet (426.7 m).

14. The method of claim 8, wherein wrapping the plurality of wires around the core to form a transmission cable comprises helically wrapping the plurality of wires around the core.

15. A transmission system comprising:
a transmission cable comprising:
a core comprising at least one of: a composite core, a plurality of fibers in a matrix of one or more materials, or a set of carbon fibers embedded in an epoxy matrix; and
a plurality of wires helically wrapped around the core, wherein the wires comprise at least one of the following: aluminum 6201 T83 alloy, 6201 T81 alloy, aluminum 1350-H19 alloy, or a heat resistant aluminum-zirconium alloy;
wherein the transmission cable has a low sag characteristic; and
at least one electrical current source connected to the transmission cable, wherein electrical current is transmitted via the transmission cable.

16. The system of claim 15, wherein the low sag characteristic is approximately 63.0 feet (19.2 m) and 90.2 feet (27.5 m) of sag with an ice thickness of approximately 2.0 inches (5.1 cm) on the transmission cable spanning about 1400 linear feet (426.7 m).

17. The system of claim 15, wherein each of the plurality of wires has a cross-section profile shape comprising: a trapezoid shape or a round shape.

18. The system of claim 15, wherein each of the plurality of wires comprises a trapezoid cross-section profile shape, and the wires are oriented to form a plurality of concentrically aligned layers of wires around the core.

19. The system of claim 17, wherein the plurality of wires comprises at least three concentrically aligned layers of wires around the core.

20. The system of claim 15, wherein the plurality of concentrically aligned layers of wires around the core comprises at least three layers.
